(19) United States
(12) Patent Application Publication
(10) Pub. No.: US 2026/0204775 A1
(43) Pub. Date: Jul. 16, 2026

(54) SATELLITE DISH BATTERY POWERED HOUSING

(71) Applicant: FENIX DEFENSE TECH, LLC, Phoenix, AZ (US)

(72) Inventor: Michael Buckmaster, Phoenix, AZ (US)

(21) Appl. No.: 19/447,252

(22) Filed: Jan. 13, 2026

Related U.S. Application Data
(60) Provisional application No. 63/744,646, filed on Jan. 13, 2025.

(51) Int. Cl. H01Q 1/42; H01M 10/42; H01M 10/46; H01M 50/244; H01M 50/247; H01M 50/271

(52) U.S. Cl. CPC H01Q 1/428; H01M 10/425; H01M 10/46; H01M 50/244; H01M 50/247; H01M 50/271; H01M 2010/4278; H01M 2220/30

(57) ABSTRACT

A satellite dish battery powered housing is provided herein. The housing includes a housing body comprising an inner volume configured to receive a satellite dish, a battery recess, and a control compartment. The housing further includes a power input, power output, ethernet port, and at least one USB port coupled to the housing body. A cover plate is removably coupled to the housing body to retain the satellite dish within the inner volume. A battery is disposed within the battery recess and retained by a removable battery cover. A controller is retained within the control compartment and coupled to the power input, power output, ethernet port, and USB port.

### CROSS-REFERENCE TO RELATED APPLICATIONS

This application claims priority to U.S. Provisional Application No. 63/744,646, filed Jan. 13, 2025, which is hereby incorporated by reference in its entirety.

### BACKGROUND

### Technical Field

The present disclosure relates to satellite dish housing, and more particularly to a satellite dish battery powered housing that retains the satellite dish within the housing and supplies battery power to the satellite dish and external devices.

### State of the Art

The utilization of small satellite dishes that provide internet connectivity is becoming increasingly popular. Some of these satellite dishes are designed to be portable and are smaller in size than other non-portable satellite dishes. Portable satellite dishes offer users the flexibility to establish internet connectivity in various locations, including remote areas where traditional wired internet infrastructure may not be available.

Small portable satellite dishes typically require an external power source to operate. These satellite dishes commonly plug into an electrical outlet, a 12V plug on a vehicle, or similar power sources. This reliance on external power sources can limit the locations and circumstances in which the satellite dishes can be deployed, particularly in situations where conventional power sources are unavailable or inconvenient to access.

Portable satellite dishes may be mounted to various structures, such as homes, vehicles, recreational vehicles, boats, and other platforms. When used in roaming or mobile applications, these satellite dishes are often subjected to environmental elements including rain, wind, dust, and temperature extremes. Such exposure can reduce the effectiveness of the satellite dish and may cause damage over time. The lack of protective enclosures for portable satellite dishes during transport and storage can further contribute to wear and potential damage.

Existing solutions for powering and protecting portable satellite dishes have not adequately addressed the combined challenges of providing battery power to the satellite dish while also offering a protective housing that retains the satellite dish within the housing. Users seeking to deploy portable satellite dishes in remote or mobile settings may find themselves managing separate power solutions and protective cases, which can be cumbersome and inefficient.

Accordingly, there exists a desire for improved satellite dish housing solutions that address power supply and environmental protection considerations for portable satellite dishes.

### SUMMARY OF THE INVENTION

In one embodiment, a satellite dish battery powered housing is provided. In this embodiment, the satellite dish battery powered housing includes a housing body comprising an inner volume configured to receive a satellite dish, a battery recess formed within the inner volume, and a control compartment formed within the inner volume. The satellite dish battery powered housing further includes a power input coupled to the housing body, a power output coupled to the housing body, an ethernet port coupled to the housing body, and at least one USB port coupled to the housing body. A cover plate is removably coupled to the housing body, wherein the satellite dish is retained within the inner volume in response to the cover plate being coupled to the housing body. A battery is disposed within the battery recess and retained within the battery recess by a battery cover removably coupled to the battery recess. A controller is retained within the control compartment and coupled to the power input, the power output, the ethernet port, and the at least one USB port.

In another embodiment, a satellite dish battery powered housing is provided. In this embodiment, the satellite dish battery powered housing includes a housing body defining an inner volume configured to receive and retain a satellite dish, the housing body comprising a battery recess and a control compartment formed within the inner volume. A cover plate is removably coupled to the housing body to enclose the inner volume and retain the satellite dish within the inner volume. A battery is disposed within the battery recess, the battery configured to supply power to the satellite dish. At least one support arm is rotatably coupled to the housing body, the at least one support arm configured to support the housing body at a predetermined angle. A plurality of ports is coupled to the housing body, the plurality of ports comprising a power input, a power output, an ethernet port, and at least one USB port.

In yet another embodiment, a method of housing and powering a satellite dish is provided. In this embodiment, the method includes providing a housing body comprising an inner volume, a battery recess formed within the inner volume, and a control compartment formed within the inner volume. The method further includes disposing a battery within the battery recess and retaining the battery within the battery recess with a battery cover removably coupled to the battery recess. The method also includes placing a satellite dish within the inner volume of the housing body and coupling a cover plate to the housing body to retain the satellite dish within the inner volume. The method additionally includes supplying power from the battery to the satellite dish via a controller retained within the control compartment.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is perspective view of a satellite dish battery powered housing, in accordance with an embodiment;

FIG. 2 is an exploded perspective view of the satellite dish battery powered housing, in accordance with an embodiment;

FIG. 3 is a perspective view of the satellite dish battery powered housing, in accordance with an embodiment; and

FIG. 4 is a side view of the satellite dish battery powered housing positioned at an angle relative to a surface, in accordance with an embodiment.

### DETAILED DESCRIPTION OF EMBODIMENTS OF THE INVENTION

As discussed above, embodiments of the present invention relate to a satellite dish battery powered housing that retains the satellite dish within the housing and supplies battery power to the satellite dish and external devices.

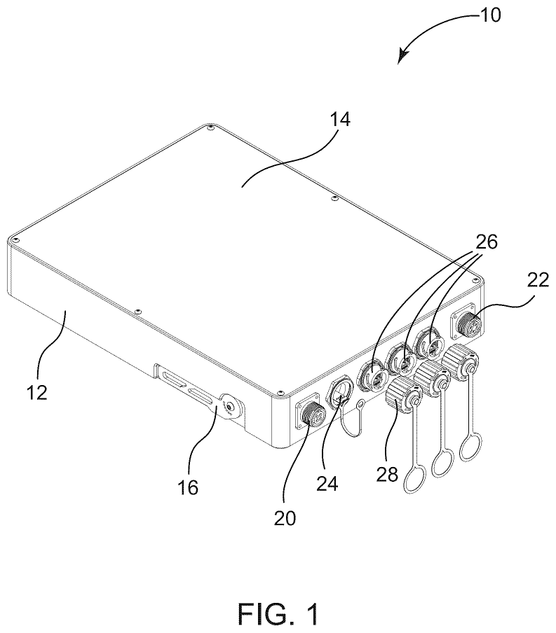

Referring to FIG. 1, a satellite dish battery powered housing 10 is shown. The satellite dish battery powered housing 10 includes a housing body 12 and a cover plate 14 removably coupled to the housing body 12. The cover plate 14 may be positioned on a top surface of the housing body 12 and may be secured by fasteners disposed at corners of the cover plate 14. The housing body 12 may have a generally rectangular box-like configuration defining an inner volume configured to receive and retain a satellite dish.

With continued reference to FIG. 1, a support arm 16 is rotatably coupled to the housing body 12. The support arm 16 may extend outward from the housing body 12 to support the satellite dish battery powered housing 10 at a predetermined angle. A plurality of ports may be coupled to the housing body 12. The plurality of ports may include a power input 20, a power output 22, an ethernet port 24, and at least one USB port 26. The power input 20 may be coupled to the housing body 12 for receiving external power. The power output 22 may be coupled to the housing body 12 for supplying power to external devices. The ethernet port 24 may be coupled to the housing body 12 to provide network connectivity. The at least one USB port 26 may be coupled to the housing body 12 for connecting USB-compatible devices. Each of the power input 20, the power output 22, the ethernet port 24, and the at least one USB port 26 may include a cap 28 attached to the housing body 12. The cap 28 may be attached via a tether and may provide protection for the respective port when not in use.

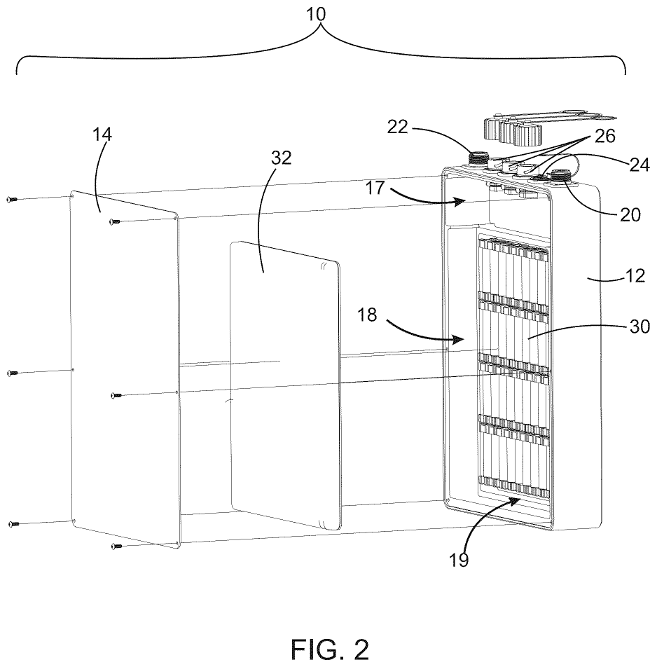

Referring to FIG. 2, an exploded perspective view of the satellite dish battery powered housing 10 is shown. The housing body 12 comprises an inner volume 18 configured to receive a satellite dish. The satellite dish may be retained within the inner volume 18 in response to the cover plate 14 being coupled to the housing body 12. The cover plate 14 may be removably coupled to the housing body 12 to enclose the inner volume 18 and retain the satellite dish within the inner volume 18.

With continued reference to FIG. 2, a battery recess 19 is formed within the inner volume 18. A battery 30 may be disposed within the battery recess 19. The battery 30 may be retained within the battery recess 19 by a battery cover 32 removably coupled to the battery recess 19. The battery cover 32 may be disposed within the inner volume 18. The battery 30 may be configured to supply power to the satellite dish when the satellite dish is received within the inner volume 18.

The battery 30 may comprise Li-Ion 18650 cells, such as, but not limited to, Panasonic NCR18650GA cells with 3540 mAh capacity. In some cases, the battery 30 comprises 48 individual cells arranged in a battery pack configuration. The battery 30 may include a 3D printed cell holder structure to retain the cells. The battery 30 may include nickel strip inter-cell connections for electrical connectivity between cells. The battery 30 may include over-pack shrinkwrap for protection.

As further shown in FIG. 2, a control compartment 17 is formed within the inner volume 18. A controller may be retained within the control compartment 17 and coupled to the power input 20, the power output 22, the ethernet port 24, and the at least one USB port 26. The controller may include a fuel gauge IC for monitoring battery state. The controller may include a cell balance and protection IC for battery management. The controller may include a battery protection MOSFET bank comprising multiple MOSFETs. The controller may include an overload current protection fuse with thermal reset capability. The controller may include polarity protection diodes to prevent reverse polarity damage. The controller may include ESD protection diodes for electrostatic discharge protection.

The controller may include a switching mode regulator with 9-60 VDC input and 12 VDC output. The controller may include an MPPT (Maximum Power Point Tracking) solar charge controller IC with 6-80 VDC buck/boost capability for solar charging. The ethernet port 24 may include an ethernet isolation choke for signal isolation.

With continued reference to FIG. 2, the cover plate 14 may comprise FR4 flat panel material. The cover plate 14 may be attached to the housing body 12 using attachment screws. The satellite dish battery powered housing 10 may include a form-in-place gasket between the cover plate 14 and the housing body 12 for sealing. The satellite dish battery powered housing 10 may include a battery isolator flexible membrane for isolating the battery 30. The satellite dish battery powered housing 10 may include a urethane bumper for satellite dish retainment within the inner volume 18. The at least one USB port 26 may comprise four USB ports for power-only USB connections. Each of the power input 20, the power output 22, the ethernet port 24, and the at least one USB port 26 may include a cap attached to the housing body 12.

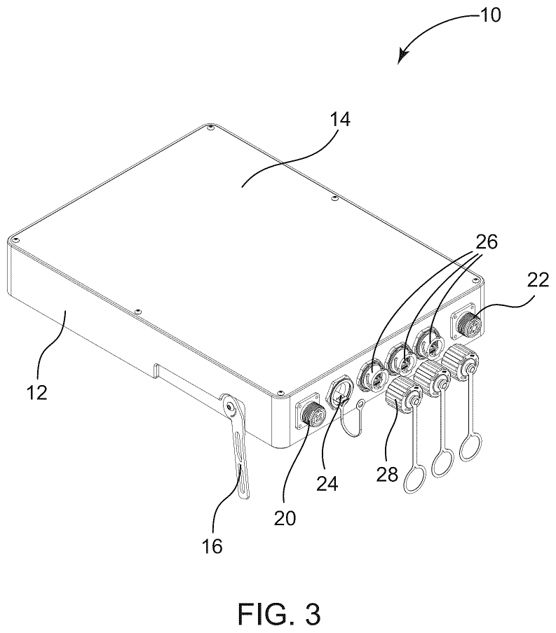

Referring to FIG. 3, the satellite dish battery powered housing 10 is shown with at least one support arm 16 extended from the housing body 12. The at least one support arm 16 is rotatably coupled to the housing body 12. The at least one support arm 16 may be of a predetermined length to support the housing body 12 at a predetermined angle. In some cases, the at least one support arm 16 comprises two support arms rotatably coupled to the housing body 12.

With continued reference to FIG. 3, a battery 30 disposed within the battery recess 19 may be configured to supply power to the satellite dish when the satellite dish is received within the inner volume 18. A power input 20 coupled to the housing body 12 may be configured to supply power to the battery 30 for charging. In some cases, the power input 20 may supply power directly to the satellite dish in addition to charging the battery 30.

A controller retained within the control compartment 17 may be configured to control power flow from the battery 30 to the satellite dish. The controller may also be configured to supply power from the battery 30 to external devices coupled to the at least one USB port 26. External devices may include mobile phones, tablets, and laptops. An ethernet port 24 coupled to the housing body 12 may provide a direct network connection to a modem internal to the satellite dish when the satellite dish is received within the inner volume 18.

The satellite dish battery powered housing 10 may protect the satellite dish from all weather conditions. The satellite dish battery powered housing 10 may be coupled to vehicles, boats, RVs, and building structures using mounting systems such as straps or magnetic mounts.

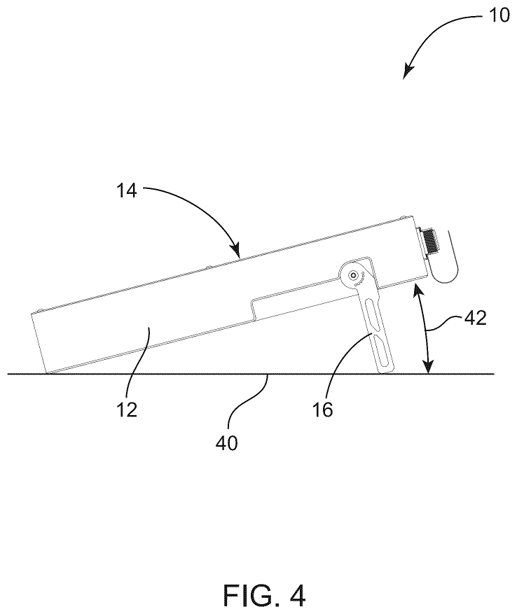

Referring to FIG. 4, the satellite dish battery powered housing 10 is shown positioned at an angle 42 relative to a surface 40. The surface 40 may be any suitable support surface, such as a ground surface, a table, a vehicle roof, or another structure upon which the satellite dish battery powered housing 10 may be placed during operation. The support arm 16 is shown extended from the housing body 12 and contacting the surface 40, thereby supporting the satellite dish battery powered housing 10 at the angle 42.

With continued reference to FIG. 4, the support arm 16 may be of a predetermined length to support the housing body 12 at a predetermined angle relative to the surface 40. The predetermined length of the support arm 16 maintains the housing body 12 at the angle 42 when the support arm 16 is extended and contacts the surface 40. In some cases, the predetermined angle 42 corresponds to an operating angle of the satellite dish when the satellite dish is received within the inner volume 18. The operating angle may be an angle at which the satellite dish achieves proper alignment for satellite connectivity. By configuring the support arm 16 to position the housing body 12 at the predetermined angle 42, the satellite dish battery powered housing 10 allows for proper positioning of the satellite dish retained within the housing body 12 to achieve alignment for satellite communication without requiring manual adjustment of the angle by a user.

Referring to FIGS. 1-4, a method of housing and powering a satellite dish may be performed using the satellite dish battery powered housing 10. The method may include providing a housing body 12 comprising an inner volume 18, a battery recess 19 formed within the inner volume 18, and a control compartment 17 formed within the inner volume 18. The housing body 12 may have a generally rectangular box-like configuration that defines the inner volume 18 configured to receive a satellite dish.

The method may further include disposing a battery 30 within the battery recess 19. As shown in FIG. 2, the battery recess 19 may be formed within the inner volume 18 to accommodate the battery 30. The method may include retaining the battery 30 within the battery recess 19 with a battery cover 32 removably coupled to the battery recess 19. The battery cover 32 may be positioned within the inner volume 18 and may be removably coupled to the battery recess 19 to secure the battery 30 in place while allowing access to the battery 30 for replacement or maintenance.

With continued reference to FIG. 2, the method may include placing a satellite dish within the inner volume 18 of the housing body 12. The inner volume 18 may be configured to receive the satellite dish such that the satellite dish is positioned within the housing body 12. The method may further include coupling a cover plate 14 to the housing body 12 to retain the satellite dish within the inner volume 18. In response to the cover plate 14 being coupled to the housing body 12, the satellite dish may be retained within the inner volume 18 and protected from environmental conditions.

The method may include supplying power from the battery 30 to the satellite dish via a controller retained within the control compartment 17. The controller may be coupled to a power input 20, a power output 22, an ethernet port 24, and at least one USB port 26. The controller may control power flow from the battery 30 to the satellite dish to operate the satellite dish.

As shown in FIGS. 3 and 4, the method may further include positioning the housing body 12 at a predetermined angle 42 relative to a surface 40 using at least one support arm 16 rotatably coupled to the housing body 12. The support arm 16 may be extended from the housing body 12 to contact the surface 40, thereby supporting the satellite dish battery powered housing 10 at the predetermined angle 42. The support arm 16 may be of a predetermined length to maintain the housing body 12 at the predetermined angle 42. The predetermined angle 42 may correspond to an operating angle of the satellite dish when the satellite dish is received within the inner volume 18. This configuration may allow for proper positioning of the satellite dish retained within the housing 10 to achieve alignment for satellite connectivity according to guidelines for the satellite dish.

The components defining any satellite dish battery powered housing may be formed of any of many different types of materials or combinations thereof that can readily be formed into shaped objects provided that the components selected are consistent with the intended operation of a satellite dish battery powered housing. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any satellite dish battery powered housing may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A satellite dish battery powered housing, comprising:
a housing body comprising:
an inner volume configured to receive a satellite dish;
a battery recess formed within the inner volume; and
a control compartment formed within the inner volume;
a power input coupled to the housing body;
a power output coupled to the housing body;
an ethernet port coupled to the housing body;
at least one USB port coupled to the housing body;
a cover plate removably coupled to the housing body, wherein the satellite dish is retained within the inner volume in response to the cover plate being coupled to the housing body;
a battery disposed within the battery recess and retained within the battery recess by a battery cover removably coupled to the battery recess; and
a controller retained within the control compartment and coupled to the power input, the power output, the ethernet port, and the at least one USB port.

2. The satellite dish battery powered housing of claim 1, further comprising at least one support arm rotatably coupled to the housing body.

3. The satellite dish battery powered housing of claim 2, wherein the at least one support arm is of a predetermined length to support the housing body at a predetermined angle relative to a surface.

4. The satellite dish battery powered housing of claim 3, wherein the predetermined angle corresponds to an operating angle of the satellite dish.

5. The satellite dish battery powered housing of claim 1, wherein the battery is configured to supply power to the satellite dish when the satellite dish is received within the inner volume.

6. The satellite dish battery powered housing of claim 5, wherein the controller is configured to control power flow from the battery to the satellite dish.

7. The satellite dish battery powered housing of claim 1, wherein the controller is configured to supply power from the battery to external devices coupled to the at least one USB port.

8. The satellite dish battery powered housing of claim 1, wherein the ethernet port provides a direct network connection to a modem internal to the satellite dish when the satellite dish is received within the inner volume.

9. The satellite dish battery powered housing of claim 1, wherein the power input is configured to supply power to the battery for charging.

10. The satellite dish battery powered housing of claim 1, wherein each of the power input, the power output, the ethernet port, and the at least one USB port includes a cap attached to the housing body.

11. The satellite dish battery powered housing of claim 1, wherein the battery cover is disposed within the inner volume.

12. A satellite dish battery powered housing, comprising:
a housing body defining an inner volume configured to receive and retain a satellite dish, the housing body comprising a battery recess and a control compartment formed within the inner volume;
a cover plate removably coupled to the housing body to enclose the inner volume and retain the satellite dish within the inner volume;
a battery disposed within the battery recess, the battery configured to supply power to the satellite dish;
at least one support arm rotatably coupled to the housing body, the at least one support arm configured to support the housing body at a predetermined angle; and
a plurality of ports coupled to the housing body, the plurality of ports comprising a power input, a power output, an ethernet port, and at least one USB port.

13. The satellite dish battery powered housing of claim 12, further comprising a controller retained within the control compartment and coupled to the power input, the power output, the ethernet port, and the at least one USB port.

14. The satellite dish battery powered housing of claim 13, wherein the controller is configured to control power flow from the battery to the satellite dish and to external devices coupled to the at least one USB port.

15. The satellite dish battery powered housing of claim 12, further comprising a battery cover removably coupled to the battery recess to retain the battery within the battery recess.

16. The satellite dish battery powered housing of claim 12, wherein the predetermined angle corresponds to an operating angle of the satellite dish when the satellite dish is received within the inner volume.

17. The satellite dish battery powered housing of claim 12, wherein each of the power input, the power output, the ethernet port, and the at least one USB port includes a cap attached to the housing body.

18. A method of housing and powering a satellite dish, comprising:
providing a housing body comprising an inner volume, a battery recess formed within the inner volume, and a control compartment formed within the inner volume;
disposing a battery within the battery recess;
retaining the battery within the battery recess with a battery cover removably coupled to the battery recess;
placing a satellite dish within the inner volume of the housing body;
coupling a cover plate to the housing body to retain the satellite dish within the inner volume; and
supplying power from the battery to the satellite dish via a controller retained within the control compartment.

19. The method of claim 18, further comprising positioning the housing body at a predetermined angle relative to a surface using at least one support arm rotatably coupled to the housing body.

20. The method of claim 19, wherein the predetermined angle corresponds to an operating angle of the satellite dish.
